(19) United States
(12) Patent Application Publication
(10) Pub. No.: US 2010/0330185 A1
(43) Pub. Date: Dec. 30, 2010

(54) ACTIVE INGREDIENT FORMULATIONS CONTAINING 2-THIAZOLE-4YL-1H-BENZOIMIDAZOL (THIABEN-DAZOLE OR TBZ) FOR THE PRODUCTION OF WPC

(75) Inventors: Andreas Boettcher, Cologne (DE); Peter Spetmann, Krefeld (DE); Martin Kugler, Leichlingen (DE); Thomas Jaetsch, Cologne (DE); Gerd-Friedrich Renner, Kurten-Biesfeld (DE); Rolf Matysiak, Duisburg (DE)

Correspondence Address: LANXESS CORPORATION, 111 RIDC PARK WEST DRIVE, PITTSBURGH, PA, 15275-1112, US

(73) Assignee: LANXESS DEUTSCHLAND GMBH, Leverkusen (DE)

(21) Appl. No.: 12/597,241

(22) PCT Filed: Apr. 17, 2008
(86) PCT No.: PCT/EP2008/054661

§ 371 Date: Sep. 16, 2010

(30) Foreign Application Priority Data
Apr. 27, 2007 (DE) 10 2007 020 450.9

(51) Int. Cl. A01N 25/12; A01N 43/78; A01N 59/14; A01P 1/00; B29C 45/70

(52) U.S. Cl. 424/489; 514/365; 424/660; 264/328.18

(57) ABSTRACT

Use of a biocidal mixture containing IPBC and TBZ for protecting wood-plastic composites (WPC), containing thermoplastic polymer and wood particles, from attack and/or destruction by microorganisms.

The present invention relates to the use of biocidal mixtures containing thiabendazole (TBZ) and 3-iodo-2-propinyl N-butylcarbamate (IPBC) for protecting composite materials comprising cellulose-containing materials (especially wood) and plastics (so-called wood-plastic composites, WPC) and to a process for the production of WPC as well as the biocidally treated WPC itself. Furthermore, TBZ-containing compositions which have a proportion of borate (measured as B₂O₃) of less than 0.1% by weight and corresponding WPC and the production thereof are described.

Since their market launch somewhat more than 10 years ago, so-called WPC (wood-plastic composites) have achieved considerable market shares with partial substitution of classical solid wood products for use outdoors (deckings, sidings).

One component of the driving force of this market trend is and was certainly the assumption that, owing to their proportion of plastic, WPC are resistant to attack by fungi. However, only shortly after the market launch of WPC for the outdoor sector, reports of fungal growth of naturally weathered WPC appeared (P. I. Morris and P. Cooper, Forest Products Journal, 1998, 48(1), 86-88) and subsequent investigations in the laboratory clearly showed the susceptibility of WPC to fungal growth (e.g. P. E. Laks, Wood Design Focus, 2000, 11(4), 7.14; M. Mankowski and J. J. Morrell, Wood and Fiber Science, 2000, 32(3), 340-345; N. M. Stark et al., Journal of Applied Polymer Science, 2003, 90(10), 2609-2617). In particular, wood-discolouring fungi and fungi causing soft rot, such as, for example, Ascomycetes and Deuteromycetes, play an important role here. In addition to said fungi, wood-destroying fungi, such as, for example, Basidiomycetes, can also attack and destroy WPC. Further studies on commercially available WPC deckings moreover showed that WPC are also capable of absorbing amounts of water which are sufficient for fungal growth (W. Wang and J. J. Morell, Forest Products Journal, 2005, 54(12), 209-212) so that, in addition to the superficial attack, it is also to be assumed that deeper layers of the composite material will be at risk.

Since, in addition to the durability and acquired freedom from maintenance, the appearance, aesthetics and haptic property are also responsible for the demand for WPC deckings, in particular the protection of the surface from attack by fungi is an important task. The abovementioned lack of resistance of WPC to biological attack therefore makes the use of biocides unavoidable. It should be noted here that the homogeneous distribution of the biocide in the material is advantageous since every inner surface of the material can become an outer surface as a result of intentional mechanical processing (sawing, milling), as a result of wear caused by use and as a result of ageing (e.g. cracking).

The fungicide most recently used today in WPC is zinc borate (J. Simonsen et al., Holzforschung [Wood Research], 2004, 58, 205-208), which however has a number of disadvantages. Thus, zinc borate firstly has higher efficacy against wood-destroying fungi than against the moulds and blue-strain fungi which impede the surface. Secondly, owing to its water solubility, zinc borate exhibits pronounced leaching. Consequently, relatively large amounts (2-10%; M. P. Wolcott et al., Forest Products Journal, 2002, 52(6), 21-27) of zinc borate are required for protecting the WPC, which also has a disadvantageous effect on the environment.

Owing to the abovementioned set of problems, organic, in particular heavy metal-free active substances or mixtures of biocidal active substances which protect the WPC from attack by fungi even when used in low concentrations are being sought.

The use of organic biocides in WPC does however represent an enormous challenge since these compounds must have sufficient stability under the conditions of production of WPC (high temperatures). For this reason, virtually exclusively inorganic biocides have been used to date.

Some experiments have already been carried out to provide alternative biocides for this application. Thus, for example, WO 2006/127649 describes partial replacements of inorganic biocides by selected organic active substances, but without being able to entirely dispense with the inorganic basis.

IPBC itself (US-A-2006/0229381) in combination with stabilizers (US-A-2006/0013847) or in combinations with the active substances ziram and/or thiram (US-A-2005/0049224) has already been described for WPC.

Tetrabromobisphenol A (TBBA) (WO-A-2004/060066), 1,2-benzisothiazolin-3-one (BIT) (US-A-2004/0076847) and some other specific active substances have already been used for WPC.

However, said solutions still have a considerable potential for improvement.

It has now been found that thiabendazole (TBZ below) has sufficient thermal stability and an excellent fungicidal action when used in WPC, the concomitant use of inorganic biocides, in particular borates, not being required.

The invention therefore relates to the use of a biocidal composition containing TBZ for protecting wood-plastic composites (WPC), containing thermoplastic polymer and wood particles, from attack and/or destruction by microorganisms, characterized in that the biocidal composition has a proportion of borate (measured as B₂O₃) of less than 0.1% by weight, preferably of less than 0.05% by weight, in particular of less than 0.01% by weight.

Determination of the proportion of borate is preferably effected by atomic absorption spectroscopy (AAS).

In the context of this invention, for example, “wood particles” are understood as meaning wood fibres, wood granules, wood flour or any other particulate form of wood. The wood particles preferably have a particle size of less than 3 mm, in particular of less than 1.5 mm, particularly preferably of less than 1 mm

The term “thermoplastic polymer” is preferably understood as meaning PVC, PET, fluoropolymers, HDPE, LDPE, LLDPE, PP, HDPP, LDPP, WHMWPE, MPE or mixtures thereof.

The biocidal composition may also be used in combinations with further fungicides against wood-destroying Basidiomycetes and/or insecticides and/or algicides.

Fungicides effective against wood-destroying Basidiomycetes include, for example: azaconazole, azocyclotin, bitertanol, bromuconazole, cyproconazole, diclobutrazole, difenoconazole, diniconazole, epoxyconazole, etaconazole, fenbuconazole, fenchlorazole, fenethanil, fluquinconazole, flusilazole, flutriafol, furconazole, hexaconazole, imibenconazole, ipconazole, isozofos, myclobutanil, metconazole, paclobutrazol, penconazole, propioconazole, prothioconazole, simeoconazole, (±)-cis-1-(4-chlorophenyl)-2-(1H-1,2,4-triazol-1-yl)cyclohepta-nol, 2-(1-tert-butyl)-1-(2-chlorophenyl)-3-(1,2,4-triazol-1-yl)propan-2-ol, tebuconazole, tetra-conazole, triadimefon, triadimenol, triapenthenol, triflumizole, triticonazole, uniconazole and the metal salts and acid adducts thereof;

the following may be mentioned as examples of algicides: acetochlor, acifluorfen, aclonifen, acrolein, alachlor, alloxydim, ametryn, amidosulfuron, amitrole, ammonium sulphamate, anilofos, asulam, atrazine, azafenidin, aziptrotryn, azimsulfuron, benazolin, benfluralin, benfuresate, bensulfuron, bensulphide, bentazone, benzofencap, benzthiazuron, bifenox, bispyribac, bispyribac sodium, borax, bromacil, bromobutide, bromofenoxim, bromoxynil, butachlor, butamifos, butralin, butylate, bialaphos, benzoyl-prop, bromobutide, butroxydim,

carbetamide, carfentrazone-ethyl, carfenstrol, chlomethoxyfen, chloramben, chlorbromuron, chlorflurenol, chloridazon, chlorimuron, chlornitrofen, chloroacetic acid, chloransulam-methyl, cinidon-ethyl, chlorotoluron, chloroxuron, chlorpropham, chlorsulfuron, chlorthal, chlorthiamide, cinmethylin, cinofulsuron, clefoxydim, clethodim, clomazone, chlomeprop, clopyralid, cyanamide, cyanazine, cycloate, cycloxydim, chloroxynil, clodinafop-propargyl, cumyluron, clometoxyfen, cyhalofop, cyhalofop-butyl, clopyrasuluron, cyclosulphamuron,

diclosulam, dichlorprop, dichlorprop-P, diclofop, diethatyl, difenoxuron, difenzoquat, diflufenican, diflufenzopyr, dimefuron, dimepiperate, dimethachlor, dimethipin, dinitramine, dinoseb, dinoseb acetate, dinoterb, diphenamide, dipropetryn, diquat, dithiopyr, diduron, DNOC, DSMA, 2,4-D, daimuron, dalapon, dazomet, 2,4-DB, desmedipham, desmetryn, dicamba, dichlobenil, dimethamid, dithiopyr, dimethametryn,

eglinazine, endothal, EPTC, esprocarb, ethalfluralin, ethidimuron, ethofumesate, ethobenzanide, ethoxyfen, ethametsulfuron, ethoxysulfuron,

fenoxaprop, fenoxaprop-P, fenuron, flamprop, flamprop-M, flazasulfuron, fluazifop, fluazifop-P, fuenachlor, fluchloralin, flufenacet, flumeturon, fluorocglycofen, fluoronitrofen, flupropanate, flurenol, fluridone, flurochloridone, fluroxypyr, fomesafen, fosamine, fosametine, flamprop-isopropyl, flamprop-isopropyl-L, flufenpyr, flumiclorac-pentyl, flumipropyn, flumioxzim, flurtamon, flumioxzim, flupyrsulfuron-methyl, fluthiacet-methyl,

glyphosate, glufosinate-ammonium

haloxyfop, hexazinone,

imazamethabenz, isoproturon, isoxaben, isoxapyrifop, imazapyr, imazaquin, imazethapyr, ioxynil, isopropalin, imazosulfuron, imazomox, isoxaflutole, imazapic,

ketospiradox,

lactofen, lenacil, linuron,

MCPA, MCPA-hydrazid, MCPA-thioethyl, MCPB, mecoprop, mecoprop P, mefenacet, mefluidide, mesosulfuron, metam, metamifop, metamitron, metazachlor, methabenzthiazuron, methazole, methoroptryne, methyldymron, methyl isothiocyanate, metobromuron, metoxuron, metribuzin, metsulfuron, molinate, monalide, monolinuron, MSMA, metolachlor, metosulam, metobenzuron,

naproanilide, napropamide, naptalam, neburon, nicosulfuron, norflurazon, sodium chlorate,

oxadiazon, oxyfluorfen, oxysulfuron, orbencarb, oryzalin, oxadiargyl,

propyzamid, prosulfocarb, pyrazolate, pyrazosulfuron, pyrazoxyfen, pyribenzoxim, pyributicarb, pyridate, paraquat, pebulate, pendimethalin, pentachlorophenol, pentoxazone, pentanochlor, petroleum oils, phenmedipham, picloram, piperophos, pretilachlor, primisulfuron, prodiamine, profoxydim, prometryn, propachlor, propanil, propaquizafob, propazine, propham, propisochlor, pyriminobac-methyl, pelargonic acid, pyrithiobac, pyraflufen-ethyl,

quinmerac, quinocloamine, quizalofop, quizalofop-P, quinchlorac,

rimsulfuron,

sethoxydim, sifuron, simazine, simetryn, sulfosulfuron, sulfometuron, sulfentrazone, sulcotrione, sulfosate,

tar oils, TCA, TCA sodium, tebutam, tebuthiuron, terbacil, terbumeton, terbutylazine, terbutryn, thiazafluoron, thifensulfuron, thiobencarb, tiocarbazil, tralkoxydim, triallate, triasulfuron, tribenuron, triclopyr, tridiphane, trietazine, trifluralin, tycor, thiadiazimin, thiazopyr, triflusulfuron,

vernolate.

The algicides are very particularly preferably triazine compounds, such as, for example, terbutryn, cybutryn, propazine or terbuton, urea compounds, such as, for example, diuron, benzthiazuron, methabenzthiazuron, tebuthiuron and isoproturon, or uracils, such as terbacil.

For example, the following are suitable as insectidal active subtances:

organo(thio)phosphates, such as acephate, azamethiphos, azinphos-methyl, chlorpy rifos, chlorpyriphos-methyl, chlorfenvinphos, diazinon, dichlorvos, dicrotophos, dimethoate, disulfoton, ethion, fenitrothion, fenthion, isoxathion, malathion, methamidophos, methidathion, methyl-parathion, mevinphos, monocrotophos, oxydemeton-methyl, paraoxon, parathion, phenthoate, phosalone, phosmet, phosphamidon, phorate, phoxim, pirimiphos-methyl, profenofos, prothiofos, sulprophos, triazophos, trichlorfon;

carbamates, such as alanycarb, benfuracarb, bendiocarb, carbaryl, carbosulfan, fenoxycarb, furathiocarb, indoxacarb, methiocarb, methomyl, oxamyl, pirimicarb, propoxur, thiodicarb, triazamate;

pyrethroids, such as allethrin, bifenthrin, cyfluthrin, cyphenothrin, cypermethrin and the alpha-, beta-, theta- and zeta-isomers, deltamethrin, esfenvalerate, ethofenprox, fenpropathrin, fenvalerate, cyhalothrin, lambda-cyhalothrin, imiprothrin, permethrin, prallethrin, pyrethrin I, pyrethrin II, silafluofen, tau fluvalinate, tefluthrin, tetramethrin, tralomethrin, transfluthrin, zeta-cypermethrin;

Arthropod growth regulators, such as a) chitin synthesis inhibitors; e.g. benzoylureas, such as chlorfluazuron, cyromazine, diflubenzuron, flucycioxuron, flu fenoxuron, hexaflumuron, lufenuron, novaluron, teflubenzuron, tritlumuron; buprofezin, diofenolan, hexythiazox, etoxazole, clofentazine; b) ecdyson antagonists, such as halofenozide, methoxyfenozide, tebufenozide; c) juvenoids, such as pyriproxyfen, methoprene, fenoxycarb; d) lipid biosynthesis inhibitors, such as spirodiclofen;

Neonicotinoids, such as flonicamid, clothianidin, dinotefuran, imidacioprid, thiamethoxam, nitenpyram, nithiazine, acetamiprid, thiacioprid;

pyrazole insectides, such as acetoprole, ethiprole, fipronil, tebufenpyrad, tolfenpyrad and vaniliprole.

Furthermore, abamectin, acequinocyl, amitraz, azadirachtin, bifenazate, cartap, chlorfenapyr, chlordimeform, cyromazine, diafenthiuron, diofenolan, emamec tin, endosulfan, fenazaquin, formetanate, formetanate hydrochloride, hydramethylnon, indoxacarb, piperonylbutoxide, pyridaben, pymetrozine, spinosad, thiamethoxam, thiocyclam, pyridalyl, fluacyprim, milbemectin, spirosmesifen, flupyrazofos, NCS 12, flubendiamid, bistrifluron, benciothiaz, pyrafluprole, pyriprole, amidoflumet, flufenerin, cyflumetofen, lepimectin, profluthrin, dimefluthrin and metaflumizone.

Preferred insectides among these are those which are effective against wood-destroying insects and in particular against the following wood-destroying insectides:

Order of the Coleoptera (beetles): Cerambycidae, such as Hylotrupes bajulus, Callidium violaceum; Lyctidae such as Lyctus linearis, Lyctus brunneus; Bostrichidae such as Dinoderus minutus; Anobiidae such as Anoblum punctatum, Xestoblum rufovillosum; Lymexylidae such as Lymexylon navale; Platypodidae such as Platypus cylindrus; Oedemeridae such as Nacerda melanura.

Order of the Hymenoptera: Formicidae, such as Camponotus abdominalis, Laslus flavus, Lasius brunneus, Laslus fuliginosus;

Order of the Isoptera (termites): Calotermitidae such as Calotermes flavicollis, Cryptothermes brevis; Hodotermitidae such as Zootermopsis angusticollis, Zootermopsis nevadensis; Rhinotermitidae such as Reticulitermes flavipes, Reticulitermes lucifugus, Coptoter mes formosanus, Coptotermes acinaciformis; Mastotermitidae such as Mastotermes darwiniensis.

These include in particular the insecticidal active substances from the class consisting of the pyrethroids, arthropod growth regulators, such as chitin biosynthesis inhibitors, ecdysone antagonists, juvenoids, lipid biosynthesis inhibitors, neonicotinoids, pyrazole insecticides and chlorfenapyr.

In particular, insecticidal active substances of the group consisting of the neonicotinoids and pyrethroids are preferred and insecticidal active substances of the group consisting of the neonicotinoids are very particularly preferred.

The biocidal composition used according to the invention preferably contains a lubricant.

A preferred lubricant which may be mentioned is at least one from the group consisting of the polymers (fluoropolymers, HDPE, LDPE, LLDPE, PP, HDPP, LDPP, WHMWPE, MPE), alkaline earth metal stearates, metal soaps, pyrogenic silicas and Zn stearate, having a content of up to 3% by weight, preferably up to 2.5% by weight and very particularly preferably up to 2% by weight, based on the biocidal composition.

The use according to the invention in which the biocidal composition consists of more than 90% by weight, preferably more than 95% by weight, of TBZ and optionally further biocidal active substances and lubricant is preferred.

The use according to the invention in which the biocidal composition is more than 90% by weight, preferably more than 95% by weight, of TBZ and lubricant is particularly preferred.

Also preferred is the use according to the invention in which the biocidal composition additionally contains a conductivity improver (e.g. graphite) with a content of up to 5% by weight, preferably with a content of up to 3% by weight and very particularly preferably with a content of up to 2.5% by weight.

The biocidal composition used is preferably present as a particulate solid preparation or in the form of a solution or dispersion of the biocidal composition in a polymer matrix (masterbatch) below.

The particulate solid preparation may be present as powder or granules. It is preferably present in a freely flowable form. The primary particles of the solid preparation preferably have a particle size of not more than 500 μm, preferably less than 100 μm, very particularly preferably less than 50 μm.

In granule form, the solid preparation preferably has a mean particle size, determined from the mass distribution, of 50 to 5000 μm, preferably 100 to 2000 μm, in particular 100 to 500 μm.

The preferably used solid preparations, in particular the lubricant-containing ones, are themselves likewise a subject of the invention. They are furthermore characterized in that they have a proportion of borate (measured as B₂O₃) of less than 0.1% by weight, in particular less than 0.05% by weight.

The masterbatch is preferably characterized by a polymer, preferably one selected from the group consisting of PVC, PET, fluoropolymer, HDPE, LDPE, LLDPE, PP, HDPP, LDPP, WHMWPE, MPE or a mixture thereof and TBZ, optionally lubricant and optionally further active substances and optionally further additives, the masterbatches, too, having a proportion of borate (measured as B₂O₃) of less than 0.1% by weight, in particular of less than 0.05% by weight.

The masterbatch itself is also a subject of the invention and preferably contains from 20 to 99% by weight of polymer, in particular 40 to 70% by weight, and 1 to 80% by weight of TBZ, in particular 30 to 60% by weight.

The invention furthermore relates to a process for the preparation of the masterbatch according to the invention, which is characterized in that a) a polymer and a biocidal composition containing TBZ are mixed or extruded together or

b) the polymer swollen in a solvent is mixed with a solution of the biocidal composition containing TBZ, and the solvents of the common mixture are separated off, preferably by distillation.

Route a) is preferably effected by compounding and extrusion of biocidal compositions, for example of the solid preparations described above, in polymers, such as for example, PET, PVC, fluoropolymers, HDPE, LDPE, LLDPE, PP, HDPP, LDPP, WHMWPE, MPE and mixtures thereof, the active substances present preferably having a content of up to 60% by weight, preferably of up to 50% by weight, in particular of up to 40% by weight, based on the masterbatch.

Route b) is preferably effected by incorporation of solutions of the biocidal compositions, in particular of the solid preparations described above, into preswollen polymers, such as, for example, PET, PVC, fluoropolymers, HDPE, LDPE, LLDPE, PP, HDPP, LDPP, WHMWPE, MPE or mixtures thereof, and subsequent removal, in particular stripping, of the solvents.

The invention furthermore relates to a process for the production of a wood-plastic composite (WPC), characterized in that wood particles, a thermoplastic polymer and a biocidal composition containing TBZ are mixed with thermal energy, in particular extruded or injection moulded, characterized in that the composition has a proportion of borate (measured as B₂O₃) of less than 0.1% by weight, in particular less than 0.05% by weight, especially less than 0.01% by weight.

The two-stage processes derived from plastic technology are preferably used for the production of water-plastic composites. Here, preferably granules of thermoplastic polymer, wood and various additives as already described above (e.g. pigments, adhesion promoters, etc.) are first produced by, for example, using heating-cooling mixers and then processed to give the actual shaped articles, for example by extrusion or injection moulding.

During the production of the WPC, the temperatures of 120 to 300° C. which are usually used for the thermoplastic polymers used are preferably applied during the thermal mixing, in particular the extrusion or the injection moulding.

The addition of the biocidal composition can be effected in the course of different production steps of a WPC.

In a particularly preferred embodiment of this invention, the biocidal compositions are added in the course of the compounding of wood particles and thermoplastic polymer, for example in the heating-cooling mixer.

In a preferred embodiment of this invention, the biocidal compositions are mixed with the wood fibres or the wood granules or the wood flour before the compounding of wood particles, e.g. wood fibres, and thermoplastic polymer or mixed with the plastic granules before the compounding of wood particles and thermoplastic polymer.

In a further embodiment of the WPC production, the biocidal compositions are converted into solutions, emulsions, suspensions or suspoemulsions by using suitable solvents and formulation auxiliaries, e.g. emulsifiers, and the wood particles to be compounded with the thermoplastic polymer are treated with these, for example by spraying on or impregnation, and these optionally dried.

Preferably 28 to 70% by weight of thermoplastic polymer (e.g. PE, PP, PET, HDPE, HDPP, PVC), 28 to 70% by weight of wood particles and 0.05 to 2% by weight, preferably 0.1 to 0.5% by weight, of the biocidal composition and optionally further additives are used for the production.

The invention furthermore relates to wood-plastic composites (WPC) containing thermoplastic polymer and wood particles, characterized in that it contains TBZ and a proportion of borate (measured as B₂O₃) of less than 0.1% by weight, in particular less than 0.05% by weight, in particular less than 0.01% by weight.

In addition to wood particles, thermoplastic polymer and the TBZ, the WPC according to the invention may contain further additives, for example from the group consisting of the adhesion promoters, lubricants, UV stabilizers, antioxidants, pigments, flameproofing agents, conductivity improvers, plastic stabilizers, the above proviso with regard to the proportion of borate of course being applicable.

The invention furthermore relates to the use of a biocidal mixture containing IPBC and TBZ, for protecting wood-plastic composites (WPC), containing thermoplastic polymer and wood particles, for attack and/or destruction by microorganisms.

Such a mixture is also effective against important fungal genera, such as, for example, Alternaria, Ulocladium and Phoma. The combinations of TBZ with IPBC moreover meet the requirements for the protection of WPC from Ascomycetes and Deuteromycetes. In addition to a pronounced synergistic increase in activity against Ascomycetes and Deuteromycetes in the case of the mixture of the two active substances, it was furthermore surprisingly and completely unexpectedly found that stabilization of IPBC against the high temperatures occurring in the production of WPC evidently occurs owing to TBZ.

This use is preferably characterized in that the biocidal mixture contains the active substances IPBC and TBZ in a ratio of 1:99 to 99:1, preferably in the ratio of 20:80 to 80:20 and very particularly preferably in the ratio of 30:70 to 70:30.

It is likewise preferred if the biocidal mixture contains a lubricant. The statements regarding the lubricant which have already been made for the biocidal composition are also applicable here. It is preferable if the biocidal mixture consists of more than 90% by weight, preferably more than 95% by weight, of IPBC, TBZ and optionally further biocidal active substances and lubricant.

In particular, the biocidal mixture consists of more than 90% by weight, preferably more than 95% by weight, of IPBC, TBZ and lubricant.

The use of a biocidal mixture which has a proportion of borate (measured as B₂O₃) of less than 0.1% by weight, in particular less than 0 05% by weight, especially less than 0.01% by weight, is furthermore preferred.

The biocidal mixture can also be used in combinations with further fungicides against wood-destroying Basidiomycetes and/or insecticides and/or algicides. Those already mentioned above are suitable as such.

The use according to the invention in which the biocidal mixture additionally contains a conductivity improver (e.g. graphite) with a content of up to 5% by weight, preferably with a content of up to 3% by weight and very particularly preferably with a content of up to 2.5% by weight is likewise preferred.

The biocidal mixture used is preferably present as a particulate solid preparation or in the form of a solution or dispersion of the biocidal mixture in a polymer matrix (masterbatch below).

The particulate solid preparation may be present as powder or granules. It is preferably present in a freely flowable form. The primary particles for the solid preparation preferably have a particle size of not more than 500 μm, preferably less than 100 μm, very particularly preferably less than 50 μm.

In granule form, the solid preparation preferably has a mean particle size, determined from the mass distribution, of 50 to 5000 μm, preferably 100 to 2000 μm, in particular 100 to 500 μm.

The preferably used solid preparations of such biocidal mixtures, in particular the lubricant-containing ones, are themselves likewise the subject of the invention, the above proviso of the proportion of borate not being applicable but being certainly preferred.

The masterbatch is preferably characterized by a polymer, preferably one selected from the group consisting of PVC, PET, fluoropolymer, HDPE, LDPE, LLDPE, PP, HDPP, LDPP, WHMWPE, MPE or a mixture thereof and TBZ, optionally lubricant and optionally further active substances and optionally further additives.

The masterbatch itself is also a subject of the invention and preferably contains from 20 to 99% by weight of polymer, in particular 40 to 70% by weight, and 1 to 80% by weight of TBZ and IPBC, in particular 30 to 60% by weight.

The invention furthermore relates to a process for the preparation of the masterbatch according to the invention, which is characterized in that

a) the polymer and a biocidal mixture containing TBZ and IPBC are mixed and are extruded together or

b) the polymer swollen in a solvent is mixed with a solution of the biocidal mixture containing TBZ and IPBC, and the solvents of the common mixture are removed, preferably by distillation.

The other preferred parameters of the process already described above are also applicable here.

The invention furthermore relates to a process for the production of a wood-plastic composite (WPC), characterized in that wood particles, a thermoplastic polymer and a biocidal mixture containing TBZ and IPBC are mixed with thermal energy, in particular extruded or injection moulded.

The two-stage processes derived from plastics technology are preferably used for the production of wood-plastic composites. Here, preferably granules of thermoplastic polymer, wood and various additives (e.g. pigments, adhesion promoters, etc.) are first prepared, for example by using heating-cooling mixers, and are then processed to give the actual shaped articles, for example by extrusion or injection moulding.

The other statements made above regarding the production of WPC are also applicable here for the mixture containing IPBC and TBZ, the proviso of the amount of borate not being compulsory here but being preferred.

The invention furthermore relates to wood-plastic composites (WPC) containing thermoplastic polymer and wood particles, characterized in that it contains TBZ and IPBC. The preferred quantity data have already been mentioned above.

### EXAMPLES

%© data denote % by weight.

### Example 1

### Production of WPC Test Specimens According to the Invention

In a heating-cooling mixer, 64% of wood flour (pine), 30% of HDPE, 0.2% of a solids mixture (49.25% of TBZ, 49.25% of IPBC and 1.5% of pyrogenic silica) and further additives (EBS wax, with phenol-formaldehyde resin, PMDI) were mixed for 10 minutes. This mixture was then introduced into the feed hopper of a twin-screw extruder equipped with a slot die and having counter rotating screws (Cincinnati Milacron 55 mm) The strips extruded at a screw or cylinder temperature of 164° C. and a die temperature of 172° C. were cooled by means of water at a temperature of 20° C. after leaving the mould.

### Example 2

### Evidence of the Resistance to Biological Attack

The evidence of the resistance to material-destroying fungi of practical relevance was obtained using an agar diffusion test based on ISO 846. For this purpose, test specimens having the dimensions 5 cm×5 cm were cut from the strips produced analogously to Example 1. The test specimens were subjected to stress by leaching by storage in water with continuous change of water (120 h; 20° C.; flow rate 12 l/h). For testing for resistance to fungi, in each case the samples stored in water as well as those not stored in water were placed on a malt extract nutrient medium and, after inoculation, were cultivated for a period of 3 weeks at a temperature of 26° C. The inoculations used had the following microorganisms: Penicillium funiculosum, Chaetomium globosum, Gliocladium virens, Paecilomyces variotii and Aspergillus niger.

The following were used as formulations according to the invention:
Formulation 1: 49.25% of TBZ, 49.25% of IPBC and 1.5% of pyrogenic silica.
Formulation 2: 32.8% of TBZ, 65.7% of IPBC and 1.5% of pyrogenic silica.

The following were used as WPC according to the invention:
WPC1: reference sample.
WPC2: 0.2% of formulation 1.
WPC3: 0.15% of formulation 2.

After testing for resistance to fungi, according to the abovementioned scheme, the following results were obtained:

| | Growth inhibition | Growth inhibition |
|---|---|---|
| | (without storage in water) | (with storage in water) |
| WPC 1 | 0/0²/0² | 0¹/0²/0² |
| WPC 2 | 3_{(2-3 mm)}/3_{(2-3 mm)}/3_{(2-3 mm)} | 2/2/2 |
| WPC 3 | 3_{(2-3 mm)}/3_{(2-3 mm)}/3_{(2-3 mm)} | 2/2/2 |

¹Aspergillus and Penicillium;
²Chaetomium globosum

The abovementioned results are based on the following rating scheme:

| | |
|---|---|
| 0 | Insufficient resistance. Attack of the sample > 10%. |
| 1 | Moderate resistance. Attack of the sample ≦ 10%. |
| 2 | Good resistance. No attack of the sample. |
| 3 | Good resistance. No attack of the sample. Occurrence |
| | of an inhibitory areola on the nutrient medium |
| | (extent of the inhibitory areola stated in mm). |

### Example 3

### Evidence of Resistance to Biological Attack

The evidence of the resistance of the WPC according to the invention also to the following material-destroying fungi of practical relevance was obtained analogously to Example 2: Fusarium sp., Bipolaris sp, Ascomycetes sp., Fusarium sp. and Aspergillus niger.

After testing for resistance to fungi according to the abovementioned scheme (Example 2), the following results were obtained:

| | Growth inhibition | Growth inhibition |
|---|---|---|
| | (without storage in water) | (with storage in water) |
| WPC 1 | 0/0/0 | 0/0/0 |
| WPC 2 | 3_{(3-4 mm)}/3_{(3-4 mm)}/3_{(3-4 mm)} | 2/2/2 |
| WPC 3 | 3_{(3-4 mm)}/3_{(3-4 mm)}/3_{(3-4 mm)} | 2/2/2 |

### Example 4

The following formulation was prepared and used analogously to Example 2.

The following were used as formulations according to the invention:
Formulation 1: 98.5% of TBZ and 0.5% of MG stearate and 1% of pyrogenic silica.

The following were used as WPC according to the invention:
WPC 1: reference sample.
WPC2: 0.25% of formulation 1.
WPC3: 0.2% of formulation 1.

Testing for a resistance to the following microorganisms was effected: Penicillium funiculosum, Chaetomium globosum, Gliocladium virens, Paecilomyces variotii and Aspergillus niger.

After testing, the following results were obtained.

| | Growth inhibition | Growth inhibition |
|---|---|---|
| | (without storage in water) | (with storage in water) |
| WPC 1 | 0/0²/0² | 0¹/0²/0² |
| WPC 2 | 3_{(2-3 mm)}/3_{(2-3 mm)}/3_{(2-3 mm)} | 2/2/2 |
| WPC 3 | 3_{(2 mm)}/3_{(2 mm)}/3_{(2 mm)} | 2/2/2 |

¹Aspergillus and Penicillium;
²Chaetomium globosum

What is claimed is:

1. Use of a biocidal mixture containing IPBC and TBZ for protecting wood-plastic composites (WPC), containing thermoplastic polymer and wood particles, from attack and/or destruction by microorganisms.

2. Use according to claim 1, characterized in that the biocidal mixture contains the active substances IPBC and TBZ in a ratio of 1:99 to 99:1, preferably in the ratio of 20:80 to 80:20 and very particularly preferably in the ratio of 30:70 to 70:30.

3. Use according to claim 1, characterized in that the biocidal mixture has a proportion of borate (measured as B₂O₃) of less than 0.1% by weight, in particular less than 0.05% by weight, especially less than 0.01% by weight.

4. Use according to claim 1, characterized in that the biocidal mixture contains a lubricant.

5. Use according to claim 1, characterized in that the biocidal mixture consists of more than 90% by weight, preferably more than 95% by weight, of IPBC, TBZ and lubricant.

6. Use according to claim 1, characterized in that the biocidal mixture is used as a particulate solid preparation or as a masterbatch.

7. Particulate solid preparation, containing IPBC, TBZ and a lubricant.

8. Particulate solid preparation according to claim 7, characterized in that it consists of more than 90% by weight, preferably more than 95% by weight, of IPBC, TBZ and lubricant.

9. Solid preparation according to claim 7, characterized in that it is present as granules having a mean particle size, determined from the mass distribution, of 50 to 5000 μm, preferably 100 to 2000 μm, in particular 100 to 500 μm.

10. Masterbatch containing polymer, IPBC and TBZ.

11. Masterbatch according to claim 10, characterized in that a PVC, fluoropolymer, HDPE, LDPE, LLDPE, PP, HDPP, LDPP, WHMWPE, MPE or a mixture thereof is suitable as the polymer.

12. Process for the preparation of a masterbatch according to claim 10, characterized in that
a) the polymer and a biocidal mixture containing IPBC and TBZ are mixed and are extruded together or
b) the polymer swollen in a solvent is mixed with a solution of a biocidal mixture containing IPBC and TBZ, and the solvent of the common mixture is separated off.

13. Process for the production of a wood-plastic composite (WPC), characterized in that wood particles, a thermoplastic polymer and a biocidal mixture containing IPBC and TBZ are mixed with thermal energy, in particular extruded or injection moulded.

14. Wood-plastic composites (WPC), containing thermoplastic polymer and wood particles, characterized in that they contain IPBC and TBZ.

15. Wood-plastic composites according to claim 14, characterized in that they have a proportion of borate (measured as B₂O₃) of less than 0.1% by weight, in particular less than 0.05% by weight, especially less than 0.01% by weight.

16. Use of a biocidal composition containing TBZ for protecting wood-plastic composites (WPC), containing thermoplastic polymer and wood particles, from attack and/or destruction by microorganisms, characterized in that the biocidal composition has a proportion of borate (measured as B₂O₃) of less than 0.1% by weight, in particular less than 0.05% by weight, especially less than 0.01% by weight.

17. Use according to claim 16, characterized in that the biocidal composition contains a lubricant.

18. Use according to claim 16, characterized in that the biocidal composition consists of more than 90% by weight, preferably more than 95% by weight, of TBZ and lubricant.

19. Use according to claim 16, characterized in that the biocidal composition is used as a particulate solid preparation or as a masterbatch.

20. Particulate solid preparation, containing TBZ and a lubricant, characterized in that it has a proportion of borate (measured as B₂O₃) of less than 0.1% by weight, in particular less than 0.05% by weight, especially less than 0.01% by weight.

21. Particulate solid preparation according to claim 20, characterized in that it consists of more than 90% by weight, preferably more than 95% by weight, of TBZ and lubricant.

22. Solid preparation according to claim 20, characterized in that it is present as granules having a mean particle size, determined from the mass distribution, of 50 to 5000 μm, preferably 100 to 2000 μm, in particular 100 to 500 μm.

23. Masterbatch containing polymer and TBZ, characterized in that a proportion of borate (measured as B₂O₃) of less than 0.1% by weight, in particular less than 0.05% by weight, especially less than 0.01% by weight, is present.

24. Masterbatch according to claim 23, characterized in that a PVC, fluoropolymer, HDPE, LDPE, LLDPE, PP, HDPP, LDPP, WHMWPE, MPE or a mixture thereof is suitable as the polymer.

25. Process for the preparation of a polymer matrix according to claim 23, characterized in that
a) the polymer and a biocidal composition containing TBZ are mixed and are extruded together or
b) the polymer swollen in a solvent is mixed with a solution of a biocidal composition containing TBZ, and the solvent of the common mixture is separated off, characterized in that it has a proportion of borate (measured as B₂O₃) of less than 0.1% by weight, in particular less than 0.05% by weight, especially less than 0.01% by weight.

26. Process for the production of a wood-plastic composite (WPC), characterized in that wood particles, a thermoplastic polymer and a biocidal composition containing TBZ are mixed with thermal energy, in particular extruded or injection moulded, characterized in that the composition has a proportion of borate (measured as B₂O₃) of less than 0.1% by weight, in particular less than 0.05% by weight, especially less than 0.01% by weight.

27. Wood-plastic composites (WPC), containing thermoplastic polymer and wood particles, characterized in that they contain TBZ and have a proportion of borate (measured as B₂O₃) of less than 0.1% by weight, in particular less than 0.05% by weight, especially
